(19) United States
(12) Patent Application Publication
(10) Pub. No.: US 2007/0256913 A1
(43) Pub. Date: Nov. 8, 2007

(54) Gaming keyboard

(76) Inventors: Poh Keng Wee, Singapore (SG); Soon Pui Lee, Singapore (SG); Poh Keng Jin, Singapore (SG); Loo Kin Leong, Singapore (SG)

Correspondence Address: Mark Manley, 5205 W 32nd, Sedalia, MO, 65301, US

(21) Appl. No.: 11/418,436

(22) Filed: May 4, 2006

(51) Int. Cl. H01H 13/72

(52) U.S. Cl. 200/5 A

(57) ABSTRACT

An apparatus of a symmetrical computer keyboard providing for use by a single hand and featuring a key matrix with a combination of keys limited to keys frequently used when playing software computer games. The apparatus features keys in a combinatorial straight grid arrangement and radial arrangement; the most frequently used keys being in the center of key matrix in said straight grid arrangement, and the less frequently used keys being in a radial arrangement. The apparatus is adapted to be equally useful for either the right hand or left hand.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### FIELD OF THE INVENTION

This invention relates to computer keyboards.

### BACKGROUND OF THE INVENTION

A computer keyboard is primarily meant as a means of inputting data into a computer and is usually operated using both hands positioned side by side for quick access over most keys when typing in data. Where the user desires to use a computer mouse, he/she would generally have to place a single hand away from the keyboard to operate the mouse.

However, when playing a computer game, a user is often required to operate both the computer mouse and keyboard simultaneously, resulting in a single-handed operation of the keyboard. This manner of operation is a common feature and requirement of computer software games of various genres such as “first-person shooters”, real-time strategy games, simulators (including racing and sports computer games), role-playing computer games or any other computer games requiring fast and accurate responses and reactions from the gamer and where time and timing is of the essence for success in the game.

Recently, people are taking to computer games more seriously with software gaming competitions involving thousands of participants and with larger prize monies. With these competitions, numerous individuals have taken to become professional ‘gamers’ who train on a constant basis in order to win and obtain larger prize monies; in such situations, quick, split-second response in playing is critical and there is an increasing need to ensure that the keyboard and mouse used by the gamer is appropriate just for the purposes of gaming.

The conventional ‘QWERTY’ keyboard is suited primarily for data-input activities such as word-processing, but is inadequate in meeting the increasing needs of a computer gamer, and as such, there exists a need for a computer keyboard designed specifically for such needs.

In light of the above, it is important for a gamer to have his hands positioned properly in relation to the keyboard so as to avoid pressing an erroneous key or becoming momentarily distracted by the numerous keys on a conventional keyboard which may be irrelevant to the game. As examples, the forward slash and back slash, sometimes referred to as solidus and reverse solidus respectively, are generally unused and irrelevant when playing computer software games. As such, there is a need for a computer keyboard featuring only keys which are relevant to the game at hand so as to facilitate the user in focusing and using only the correct keys and to avoid erroneous pressing of irrelevant keys.

The conventional ‘QWERTY’ keyboard is suitable for two-handed operation and is commonly longer than it is wide. However, in a single-handed operation of the keyboard commonly necessary in playing software games, the user would often have to move his/her hand across the keyboard in accessing various keys. As an example, in a conventional keyboard, the keys are arranged such that the Q button and the ‘Enter’ button are commonly sufficiently far apart as to require a user to move his/her hand across the keyboard in order to press both the buttons in succession. This is unsuitable for the needs of a gamer, as time is wasted moving his/her hand across the keyboard and serves to unnecessarily increase the reaction time of the user; further, the movement of a single hand across the keyboard increases the risk of erroneous pressing of wrong or irrelevant keys.

Further, for single-handed operation of the keyboard, there is a need to cater to both left-handers and right-handers in relation to the above, as some gamers respond quicker and feel more comfortable using their left-hands in pressing the relevant keys and vice-versa.

The prior art reveals keyboards for single-handed operation, including U.S. Pat. No. 6,333,734 issued to Rein and U.S. Pat. No. 5,847,697 issued to Sugimoto, both of which feature a smaller number of physical keys and both of which require the combinatory and simultaneous pressing of keys for resolution of character input. Further, U.S. Pat. No. 6,102,594 issued to Strøm also features a smaller number of physical keys and resolution of character input is dependent on either the number of successive key presses or the duration over which a key is pressed.

The single-handed operation keyboards described above are unsuited for playing software games requiring rapid responses from the user.

The prior art further reveals Chinese Registered Design Numbers CN3389208, CN3372300 and CN3441241, all of which reveal keyboard designs which are non-symmetrical and to be used primarily by the left hand and do not seem to be suitable for right-handed use.

In addition, in a conventional computer keyboard, it is a common feature that the alphabetical and numeric keys are of the approximate same size partly due to the limited space on a conventional keyboard and partly due to the fact that all one-hundred-and-one keys on a keyboard should be accessible to the user for data-input purposes. Further, it is a common feature of a conventional keyboard for the keys to be arranged in a tiled manner in order to facilitate data input. This feature is unsuited for the purposes of gaming, where it would be more appropriate for the keys to be aligned vertically in order to avoid any confusion as to the position of the keys without any need for the user to visually check the position of his/her fingers in relation to the keys.

In light of the above, there is a growing demand for computer peripherals such as computer keyboards designed specifically for the purpose of gaming and to facilitate gamers in playing their games more effectively, these needs being beyond the original intended design of the conventional computer keyboard.

### SUMMARY OF THE INVENTION

It is a primary object of the present invention to provide a keyboard ergonomic for the purposes of playing computer software games.

It is a further object of the present invention to provide an apparatus that enables the comfortable operation of a computer keyboard by a user using a single hand in such manner that all keys on the keyboard are easily accessible without the need for excessive movement of the hand over the keyboard.

Yet another object of the invention is to provide an apparatus in which the arrangement and configuration of the physical keys on the keyboard are laterally symmetrical so as to facilitate equal comfort levels between right-handed users and left-handed users of the invention. Further, a laterally symmetrical keyboard caters to the lateral symmetry of a hand at rest. A further benefit of a laterally symmetrical keyboard is that in the event where a user tires of using one specific hand in operating the keyboard, he/she is provided with the option of conveniently switching to the other hand without any need for reconfiguring the keyboard. This option of equal ease of use between both hands may also serve to avoid repetitive strain injury, as the user may easily switch hands where strain from constant use by one hand becomes a concern.

In addition, in considering the industrial application of the invention, a laterally symmetrical keyboard eliminates any requirement for a manufacturer of the keyboard to produce a right-handed version and left-handed version.

It is a further object of the invention to provide an apparatus in which the more frequently used keys are larger and centrally located and arranged in a predetermined matrix to facilitate timely access, thus making these keys more accessible than keys which are used less frequently.

To achieve the above objects, according to a preferred embodiment of the present invention, an apparatus comprises: a laterally symmetrical computer keyboard to be operated using a single hand, featuring a predetermined and limited set of alpha-numeric keys relevant to the playing of computer software games.

In a primary embodiment, a predetermined set of alphabetical keys which are more frequently used when playing a set of computer games are central to the keyboard and are arranged in a tiled, straight matrix, that is, with the keys being horizontally and vertically aligned in order to facilitate comfortable and timely access.

Further, a sub-set of frequently used keys are larger in surface area, shaped to be vertically taller and located centrally in order to provide the user with the option of accessing these keys by way of his/her thumb.

A further predetermined set of alphabetical keys commonly relevant to computer software games but less frequently used are located above, below and to either side of said key matrix.

In addition, a further set of numerical keys and function keys are radially configured and arranged.

### DESCRIPTION OF THE DRAWINGS

FIG. 1 is a top view showing key matrix 70 of the invention and keyboard casing 80.

FIG. 2 is a top sectional view showing section 30 of the keyboard and the keys located within said section.

FIG. 3 is a top sectional view showing section 60 of the keyboard and the keys located within said section.

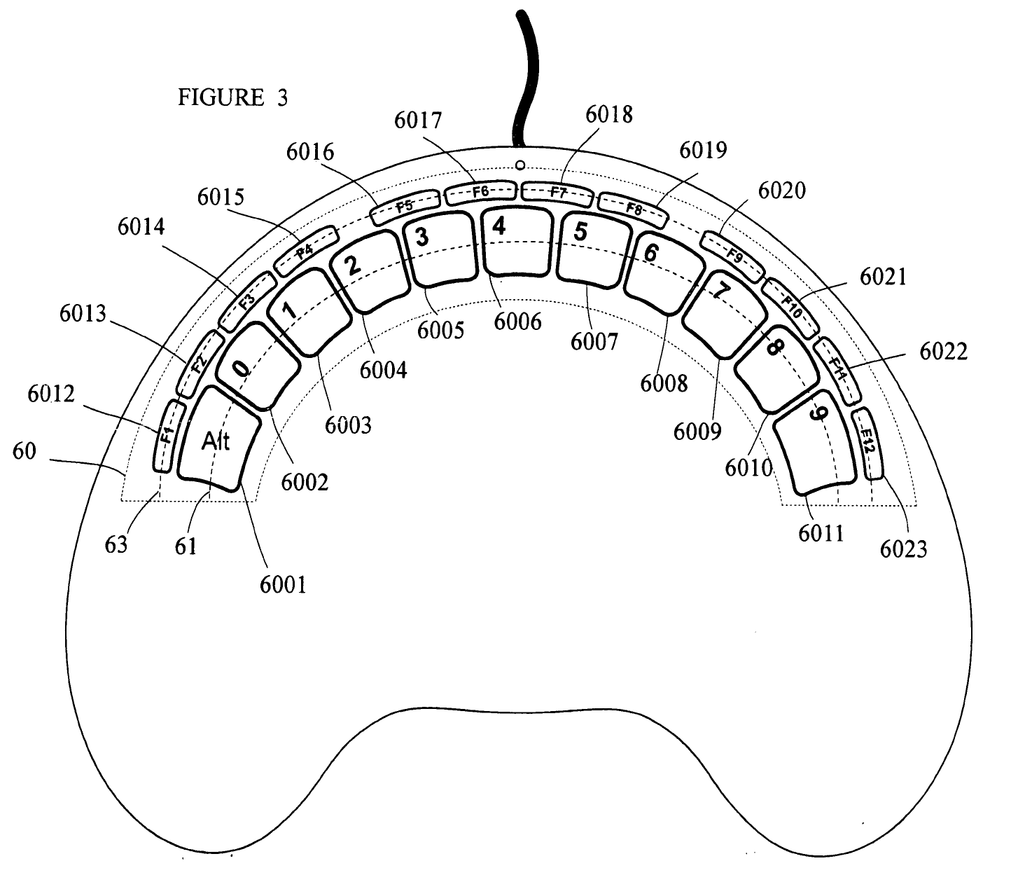

FIG. 4 is a top sectional view showing section 40 of the keyboard and the keys located within said section.

FIG. 5 is a top sectional view showing section 50 of the keyboard and the keys located within said section.

FIG. 6 is a top view showing the invention in relation to a left hand resting in rest position A.

### DETAILED DESCRIPTION OF THE PREFERRED EMBODIMENTS

Within the present description, unless otherwise indicated, it is assumed that a user of the invention is using his/her left hand in operating the apparatus.

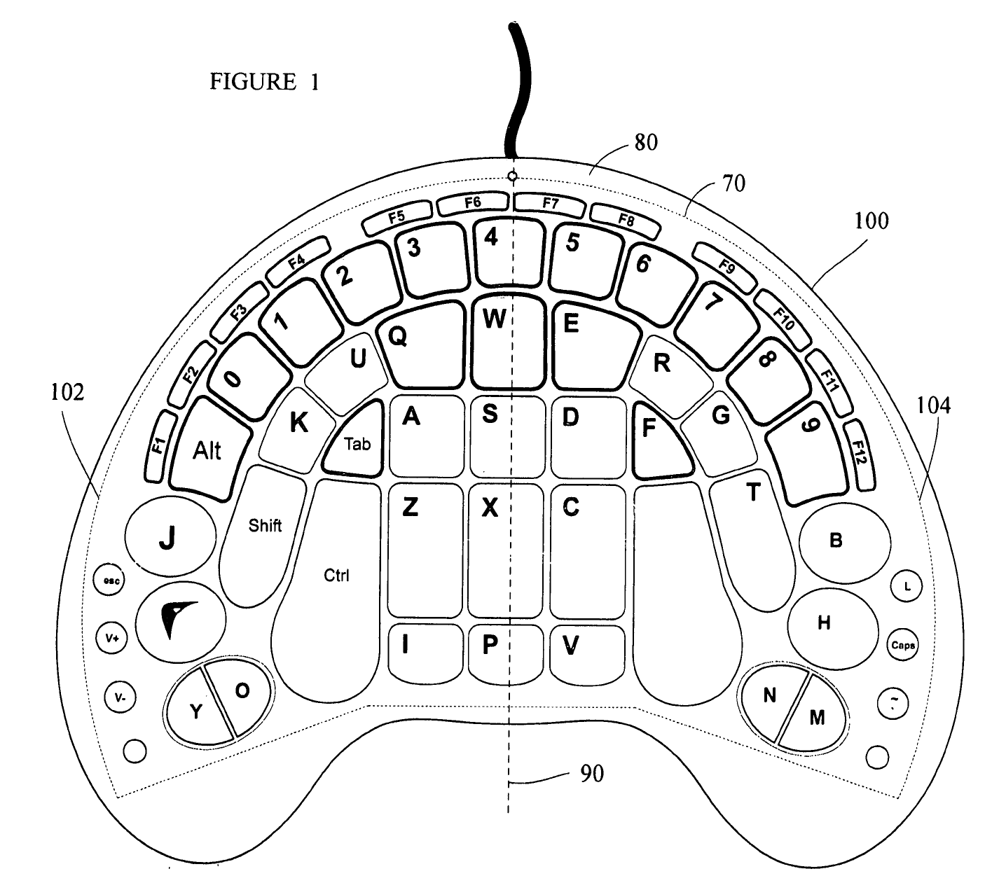

FIG. 1 shows a preferred embodiment of the keyboard 100, including key matrix 70 of the invention and keyboard casing 80.

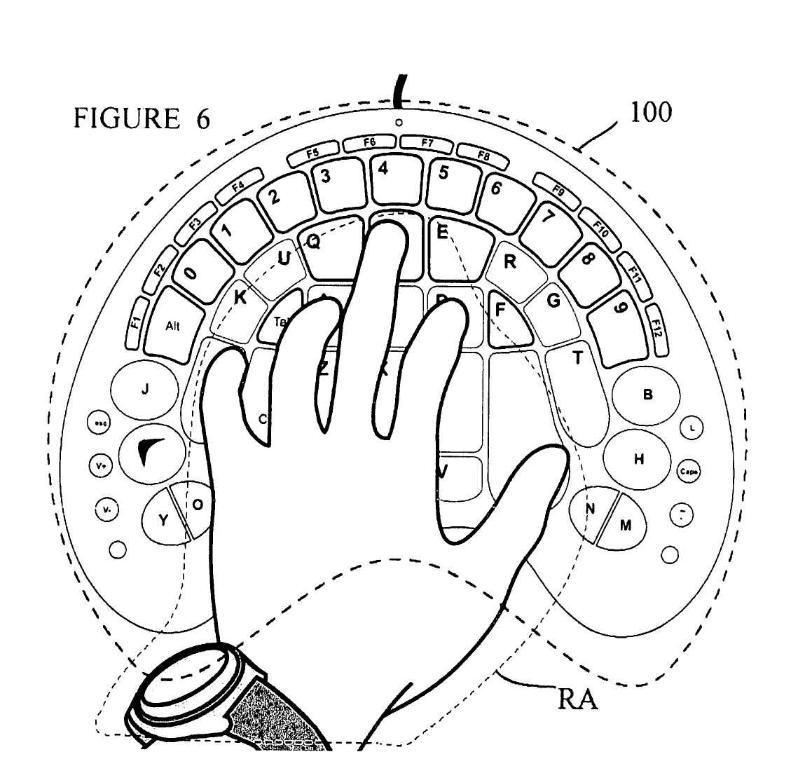

Keyboard casing 80 of the invention is semi-circular in shape similar to the radial arrangement of a user's fingertips when his/her hand is placed in rest position RA (shown in FIG. 6).

Within a primary embodiment, the keys of the invention are physically and laterally symmetrical through the center vertical axis 90 of the keyboard 100, that is, the physical shape, configuration and arrangement of keys on the left side 102 of the keyboard 100 are a mirror image to the physical shape, configuration and arrangement of keys on the right side 104 of the keyboard 100. Physically, there is little or no difference in the operation of the keyboard 100 between a left-handed user and a right-handed user.

The invention may be placed flat on a surface such as a table or may be supported by stands on the underside of the keyboard 100 which can be extended to enable the invention to rest at an angle to the horizontal.

Further, area 20 is intentionally cut inwards and left empty so as to provide the user with an area to rest his/her palm or to place padding in area 20 for such purpose while ensuring that most of the keys of the keyboard 100 remain within reach.

As shown in FIG. 6, an intended and comfortable position is for the user to place his/her thumb, index finger, middle finger, ring finger and last finger over keys 5010 (enter key), 3014 ‘D’, 3013 ‘W’, 3012 ‘A’and 4010 ‘shift’ respectively while resting his/her palm in area 20, referred to in this description as rest position RA.

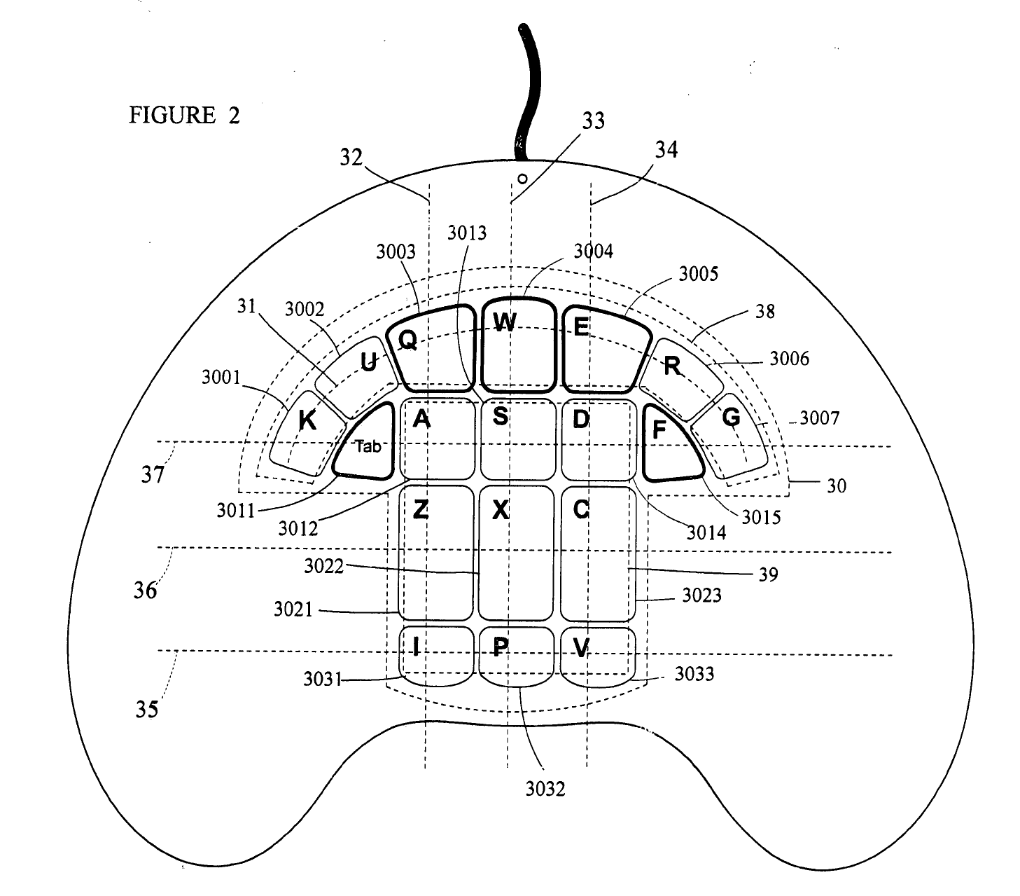

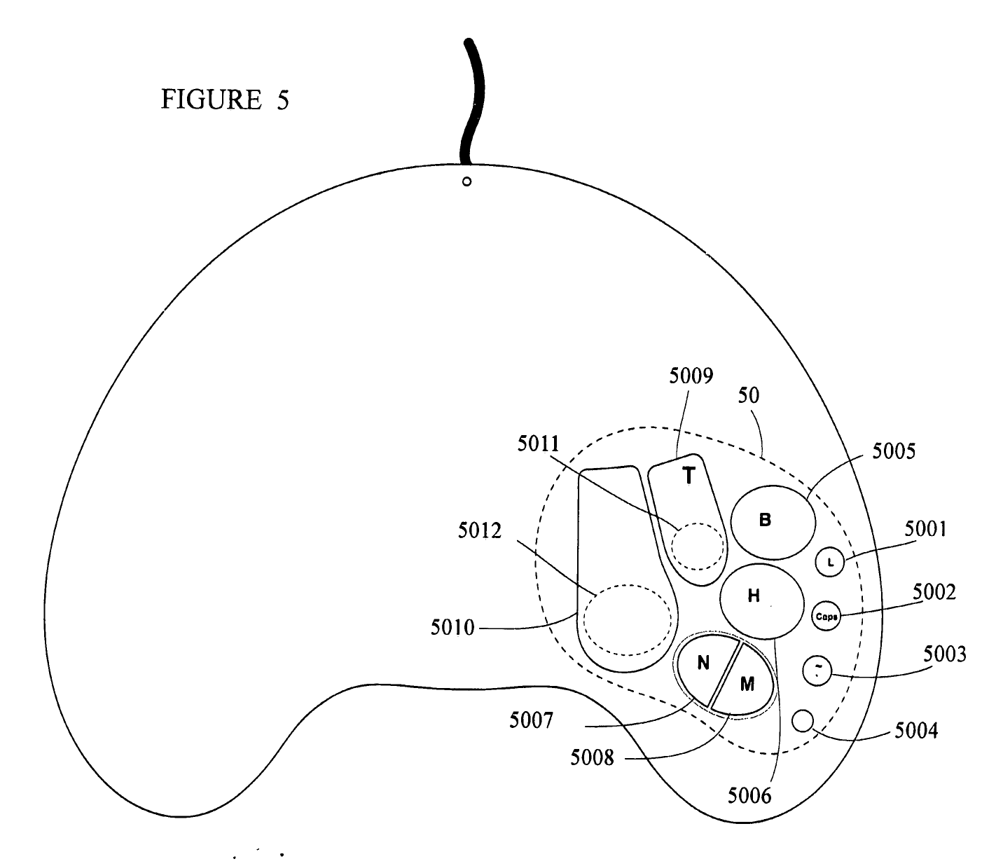

A user with his/her left hand in rest position RA would have convenient and rapid access to keys 3021, 3022, 3023, 3031, 3032, 3033 (see FIG. 2), and all the keys located in section 50 (see FIG. 5) using his/her thumb. Similarly, using his/her index finger from rest position RA, a user would have convenient and rapid access to keys 3014, 3005, 3006, 3007, 3015, 3023, 2007, 2008, 2009, 2010 and 2011. From rest position RA, the middle finger may be used to access keys 2005, 2006, 2007, 3004, 3013, and 3022. From rest position RA, the ring finger may be used to access keys 3012, 3003, 3002, 3001, 3011, 2005, 2004, 2003, 2002 and 2001. From rest position RA, the last finger may be used to access all keys in section 40.

FIG. 2 shows section 30, being the central section of key matrix 70. Section 30 is located in the center of key matrix 70 as it involves keys which are most often used when playing computer software games. The keys in the three center columns of section 30 are aligned vertically so as to enable a user to rapidly find these keys by way of touch as his/her index finger, middle finger and ring finger travel up and down said columns. This arrangement reduces the probability of error as fingers travel vertically. This arrangement of vertical alignment of keys is contrasted with a conventional computer keyboard, in which the keys are usually arranged in a staggered, vertically unaligned manner. A left vertical column of keys 32 includes keys 3003, 3012,3021, and 3031; the middle column of keys 33 is made up of keys 3004, 3013, 3022 and 3032; the right column of keys 34 is made up of keys 3005, 3014, 3023 and 3033

Radial key set 38 consists of keys 3001, 3002, 3003, 3004, 3005, 3006, 3007, 4009 and 5010 arranged in a radial manner that is similar to the radial positions of the fingertips of a palm resting on key matrix 70 in rest position RA. This radial key set 38 arrangement provides the user with comfortable and quick access from rest position RA in accessing the keys on arc 31 passing through the radial key set 38. As can be seen in FIG. 2 there is a set of keys 38 that creates an arc 31 that surrounds a set of keys 39 laid out on horizontal (35,36,37) and vertical (32,33,34) lines. The combination of commonly used set of keys 39 in the horizontal and vertical lines and the radial arc of keys 38 surrounding them creates an ergonomic keyboard arrangement for the gamer use. As can be seen the center of arc 31 (approximately where vertical line 33 intersects horizontal line 36) falls out on the ‘X’ key 3022 which is the approximate center of the horizontal/vertical keyset 39. As can be seen in FIGS. 2 and 6 the radial key set 38 is adjacent the finger tips of a user and adjacent the outer edge of the keyboard case.

Keys 3032, 3033 and 3034 are elongated in shape and generally accessed using the index finger, middle finger and ring finger respectively. The elongated shape of these keys provides the user with the additional option of pressing said keys using his/her thumb by moving the thumb beneath his/her palm while fingers remain rested on the keys above.

In a primary embodiment, within section 30, keys 3001, 3002, 3003, 3004, 3005, 3006 and 3007 are keys for the letters K, U, Q, W, E, R and G respectively; key 3011 is a key for tabulation; keys 3012, 3013, 3014 and 3015 are keys for the letters A, S, D and F respectively; keys 3021, 3022 and 3023 are keys for the letters Z, X and C respectively; and keys 3031, 3032 and 3033 are keys for the letters I, P and V respectively.

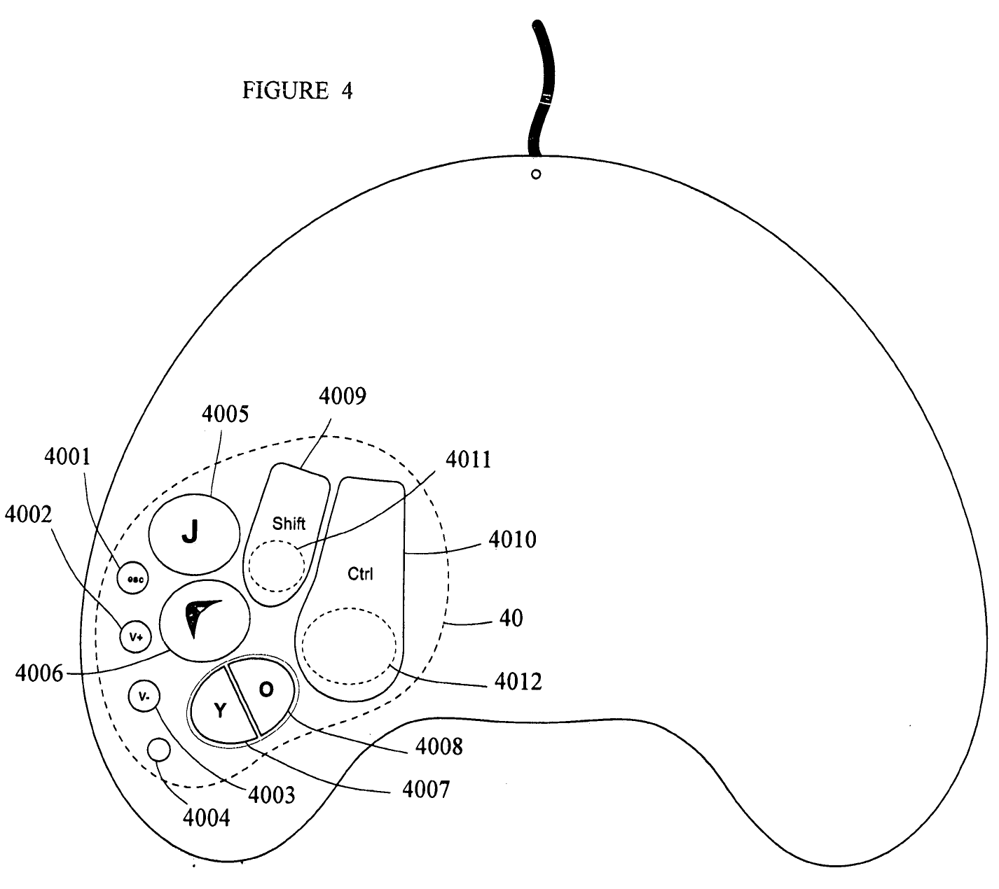

All keys located in section 40 (see FIG. 4) are accessed by the user using his/her last finger; further, all keys located in section 50 are accessed by the user using his/her thumb. Keys 4005, 4006, 4009, 4010, 5005, 5006, 5009 and 5010 feature a larger surface area as they are generally accessed more frequently. The large, rounded ends 4011, 4012 and 5011, 5012 of keys 4009, 4010, 5009 and 5010 respectively provide for comfortable pressing of these keys where the thumb is used.

In a primary embodiment, within section 40, key 4001 is an ‘escape’ key, also referred to as ‘esc’ key; key 4002 and 4003 are volume increase and volume decrease keys respectively; key 4004 is a key to switch on and off lights from within the keyboard; keys 4005, 4007 and 4008 are keys for the letters J, Y and O respectively; key 4006 is an ‘enter’ key; key 4009 is a ‘shift’ key; and key 4010 is a ‘control’ key, also referred to as ‘ctrl’ key.

In a primary embodiment, within section 50, keys 5001, 5005, 5006, 5007, 5008 and 5009 are keys for the letters L, B, H, N, M and T respectively; key 5002 is a key serving as a caps lock; key 5003 is a key for the tilde mark; key 5004 is a key to switch on and off lights a projector light from within the keyboard; and key 5010 is a key for the ‘space’ character.

All keys positioned in section 60 are arranged in a radial manner that is similar to the radial positions of the fingertips of a palm resting on key matrix 70. This radial arrangement provides the user with comfortable access from rest position RA in accessing keys in section 60.

In a primary embodiment, within section 60, key 2001 is a key for ‘alternate’, also referred to as ‘alt’; keys 6002, 6003, 6004, 6005, 6006, 6007, 6008, 6009, 6010, 6011 are keys for 0 to 9 respectively and lay on a second arc 61 surrounding the first key arc 31; and keys 6012, 6013, 6014, 6015, 6016, 6017, 6018, 6019, 6020, 6021, 6022 and 6023 are for function keys F1 to F12 and these lay on a third arc 63 surrounding the first and second arcs.

Within this description, as mentioned for a primary embodiment, a specific set of alphabets, numbers, functions and symbols has been ascribed to the keys within key matrix 70; however, in further embodiments, further sets of alphabets, numbers, functions and symbols different and dissimilar to the specific set mentioned may be ascribed in different and dissimilar combinations and arrangements.

1. A symmetrical gaming keyboard including;
a first set of keys laid out radially on the keyboard on an arc,
a second set of keys laid out with a plurality of keys lying horizontally next to one another and also with a plurality of keys lying in vertical columns;
wherein the second set of keys is surrounded by the arc created by the first set of keys and wherein the approximate center of the arc falls within an area covered by the first set of keys

2. The gaming keyboard of claim 1 including;
a third set of keys arranged in a second arc wherein said second arc is concentric with said first arc.

3. The symmetrical gaming keyboard of claim 1 including;
an symmetrical arc shaped keyboard casing.

4. The symmetrical gaming keyboard of claim 1 wherein some keys within said second set of keys are vertically longer than other keys within the vertical set of keys.

5. The symmetrical gaming keyboard of claim 1 wherein the second set of key includes 9 commonly used letter keys.

6. The symmetrical gaming keyboard of claim 3 wherein the arc shaped keyboard casing includes a cutaway palm rest area such that a user can use the keyboard with a single hand having a rest position.

7. A symmetrical gaming keyboard to be keyed with one hand including;
a first set of keys laid out radially on the keyboard on an arc adjacent the finger tips of a user,
a second set of keys laid out with a plurality of keys lying horizontally next to one another and also with a plurality of keys lying in vertical columns at least partially under the palm of a user;
wherein the second set of keys is partially surrounded by the arc created by the first set of keys and wherein the approximate center of the arc falls within an area covered by the first set of keys.

8. The symmetrical gaming keyboard of claim 7 including a third set of keys arranged in a second arc wherein said second arc is concentric with said first arc.

9. The symmetrical gaming keyboard of claim 8 wherein said first second and third set of keys are arranged on an arc shaped keyboard case.

10. The symmetrical gaming keyboard of claim 9 wherein some keys within said first, second and third sets of keys are vertically longer than other keys in the sets.

11. The symmetrical gaming keyboard of claim 10 wherein the second set of key includes 9 commonly used letter keys and wherein the third set of keys includes the number keys 0-9.

12. The symmetrical gaming keyboard of claim 11 wherein the arc shaped keyboard case includes a cutaway palm rest area such that a user can use the keyboard with a single hand having a rest position and wherein either a left handed user or a right handed user would rest their palm in the rest position.

13. (canceled)

14. (canceled)

15. (canceled)

16. (canceled)

17. (canceled)
